(19) United States
(12) Patent Application Publication
(10) Pub. No.: US 2006/0114348 A1
(43) Pub. Date: Jun. 1, 2006

(54) Digital camera and lens barrel unit for digital camera

(76) Inventors: Naoki Fujii, Tokyo (JP); Yoichi Washizu, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 10/538,967

(22) PCT Filed: Dec. 25, 2003
(86) PCT No.: PCT/JP03/16696

§ 371 Date: Jun. 14, 2005

(30) Foreign Application Priority Data
Dec. 26, 2002 (JP) 2003-377998

(51) Int. Cl. H04N 5/225

(52) U.S. Cl. 348/373

(57) ABSTRACT

In a digital camera (1), an LCD display unit (11) is arranged to the back of a lens barrel (3) having a CCD substrate (9) arranged to the right of the camera, and the components around the lens barrel are assembled as a unit while an image pickup substrate (10) is arranged to the left of the lens barrel (3). Further, a battery chamber (24a) and electric substrates ((A)6 and (B)7) are arranged to the left of the camera, a strobe light-emitting unit (5) is arranged to the top in the center of the camera and a strobe condenser (14) is accommodated on the back of the strobe light-emitting unit (5) in a long space sandwiched by the battery chamber (24a) and the lens barrel (3).

### TECHNICAL FIELD

The present invention relates to the inner layout and structure of a digital camera.

### BACKGROUND ART

Conventionally, the compact outside-size is always required for digital cameras in mobility. For example, Japanese Unexamined Patent Application Publication No. 11-8786 proposes, in view of the compact size, a camera having the layout of arrangement of a battery, a strobe condenser, a main substrate, and a taking lens in the lateral direction (right/left direction) from the left end as viewed from a subject side of the camera.

Further, Japanese Unexamined Patent Application Publication No. 11-266377 discloses a camera having the layout of arrangement of a battery on the left end of the camera (as viewed from a subject side), a taking lens in the center of the camera, and a strobe condenser on the right end of the camera.

The layouts of the cameras disclosed in Japanese Unexamined Patent Application Publication No. 11-8786 and Japanese Unexamined Patent Application Publication No. 11-266377 have the arrangements with the compact size. However, those layouts do not satisfy the effective arrangements of components in the camera without the deterioration in original functions of the camera.

The present invention is devised in consideration of the above circumferences. It is an object of the present invention to provide a digital camera that is compact without deteriorating the original functions of the digital camera by effectively arranging inner components of the digital camera, and a lens barrel unit for the digital camera.

### DISCLOSURE OF INVENTION

According to a first invention, a digital camera comprises: a taking-lens barrel arranged on the right of the camera as viewed from a subject; an electric substrate on the side of the barrel attached to the side surface on the left as viewed from the subject of the taking-lens barrel in the vertical direction of a camera width direction; an image display unit attached to the back of the taking-lens barrel; a battery chamber having therein a battery storage space, arranged on the left of the camera as viewed from the subject with a principal plane thereof in the camera width direction; a strobe light-emitting unit arranged upward of the front and nearly the center of the camera width direction; and a strobe condenser arranged on the back of the strobe light-emitting unit in a long space formed sandwiched by the electric substrate and the battery chamber in the direction in which the longitudinal direction of the strobe condenser matches the long direction of the space.

According to a second invention, the digital camera according to the first invention further comprises: an electric substrate in front of the battery chamber close to a substrate surface of the electric substrate on the side of the barrel at one end thereof, attached to the front side of the battery chamber in the camera width direction and arranged to cover the front side of the strobe condenser.

According to a third invention, a digital camera comprises: a taking-lens barrel including a taking lens and an image pickup element; a lens driving unit for moving the taking lens, attached to one side in front of the taking-lens barrel to be at least partly projected from the side of the taking-lens barrel; an image display unit arranged to the back of the taking-lens barrel in the parallel direction of the back of the taking-lens barrel to be partly projected from the back of the taking-lens barrel in the same side direction as the projected direction of the lens driving unit; and an image pickup substrate arranged on the side of the taking-lens barrel, sandwiched by the lens driving unit and the projected portion of the image display unit along the side of the lens barrel.

According to a fourth invention, the digital camera according to the third invention further comprises: an image pickup element substrate, on which the image pickup element is mounted, between the image display unit and the back of the lens barrel in parallel with the image display unit.

According to a fifth invention, a lens barrel unit for digital camera, comprises: an electric substrate on which an image pickup element is mounted; a taking-lens barrel including a taking lens for forming a subject image onto the image pickup element; and an image display unit for displaying the image based on an image signal obtained by the image pickup element, wherein the electric substrate is attached to the back of the taking-lens barrel and the image display unit is attached for integration, in parallel with the electric substrate to cover the electric substrate.

According to a sixth invention, a digital camera for recording image information, comprises: a taking-lens barrel arranged to the right of the camera as viewed from a subject; an electric substrate on the side of the barrel attached to the left side as viewed from the subject of the taking-lens barrel in the direction vertical to a camera width direction; an image display unit attached to the back of the taking-lens barrel; a battery chamber having therein a battery storage space, arranged on the left of the camera as viewed from the subject with a principal plane thereof in the camera width direction; a strobe light-emitting unit arranged to the front top in the center of the camera width direction; and a strobe condenser arranged on the back of the strobe light-emitting unit in a long space formed sandwiched by the electric substrate and the battery chamber in the direction in which the longitudinal direction of the strobe condenser matches the long direction of the space.

According to a seventh invention, the digital camera according to the sixth invention further comprises: an electric substrate in front of the battery chamber close to a substrate surface of the electric substrate on the side of the barrel at one end thereof, attached to the front side of the battery chamber in the camera width direction and arranged to cover the front side of the strobe condenser.

According to an eighth invention, a digital camera for recording image information comprises: a taking-lens barrel including a taking lens and an image pickup element; a lens driving unit for moving the taking lens, attached to one side in front of the taking-lens barrel to be at least partly projected from the side of the taking-lens barrel; an image display unit arranged to the back of the taking-lens barrel in the parallel direction of the back of the taking-lens barrel to be partly projected from the back of the taking-lens barrel in the same side direction as the projected direction of the lens driving unit; and an image pickup substrate arranged on the side of the taking-lens barrel, sandwiched by the lens driving unit and the projected portion of the image display unit along the side of the lens barrel.

According to a ninth invention, the digital camera according to the eighth invention further comprises: an image pickup element substrate, on which the image pickup element is mounted, between the image display unit and the back of the lens barrel in parallel with the image display unit.

According to a tenth invention, a lens barrel unit for digital camera for converting a subject image into an image signal comprises: an electric substrate on which an image pickup element is mounted; a taking-lens barrel including a taking lens for forming a subject image onto the image pickup element; and an image display unit for displaying the image based on an image signal obtained by the image pickup element, wherein the electric substrate is attached to the back of the taking-lens barrel and the image display unit is attached for integration, in parallel with the electric substrate to cover the electric substrate.

### BRIEF DESCRIPTION OF THE DRAWINGS

FIG. 1 is a perspective view showing the appearance of a digital camera according to an embodiment of the present invention;

FIG. 2 is a perspective view showing the inner arrangement of the digital camera shown in FIG. 1 from the side of a subject;

FIG. 3 is a perspective view showing the inner arrangement of the digital camera shown in FIG. 1 from the top;

FIG. 4 is an exploded perspective view showing the digital camera shown in FIG. 1; and

FIG. 5 is an exploded perspective view showing an assembling unit around a lens barrel of the digital camera shown in FIG. 1.

### BEST MODE FOR CARRYING OUT THE INVENTION

Hereinbelow, a description is given of an embodiment of the present invention with reference to the drawings.

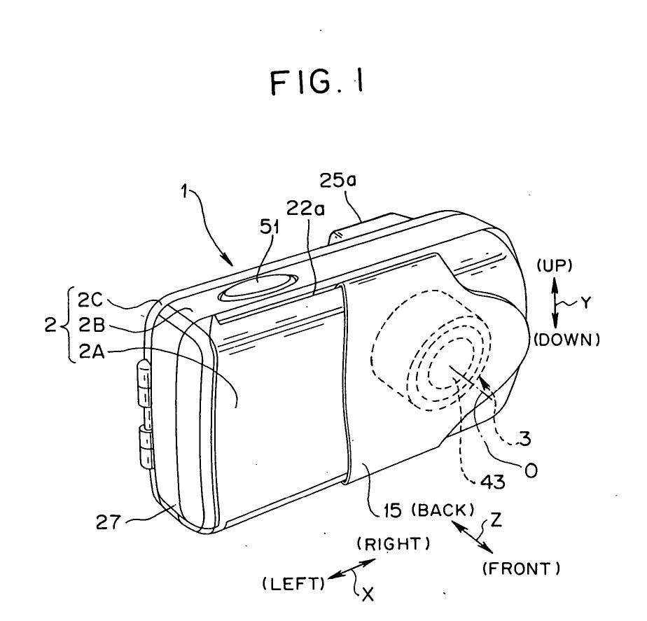

FIGS. 1 to 5 show the embodiment of the present invention.

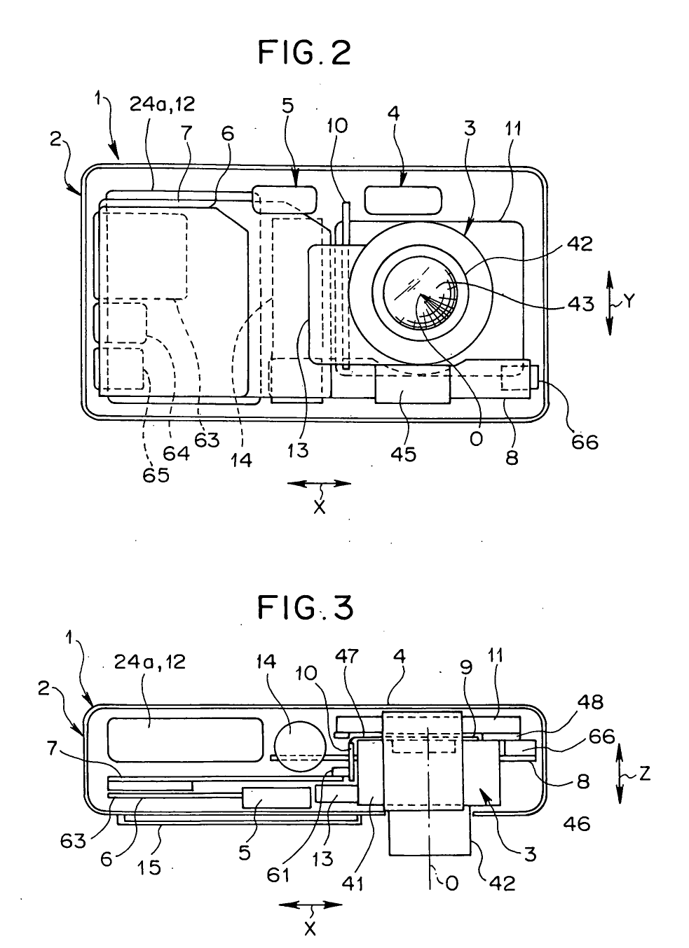

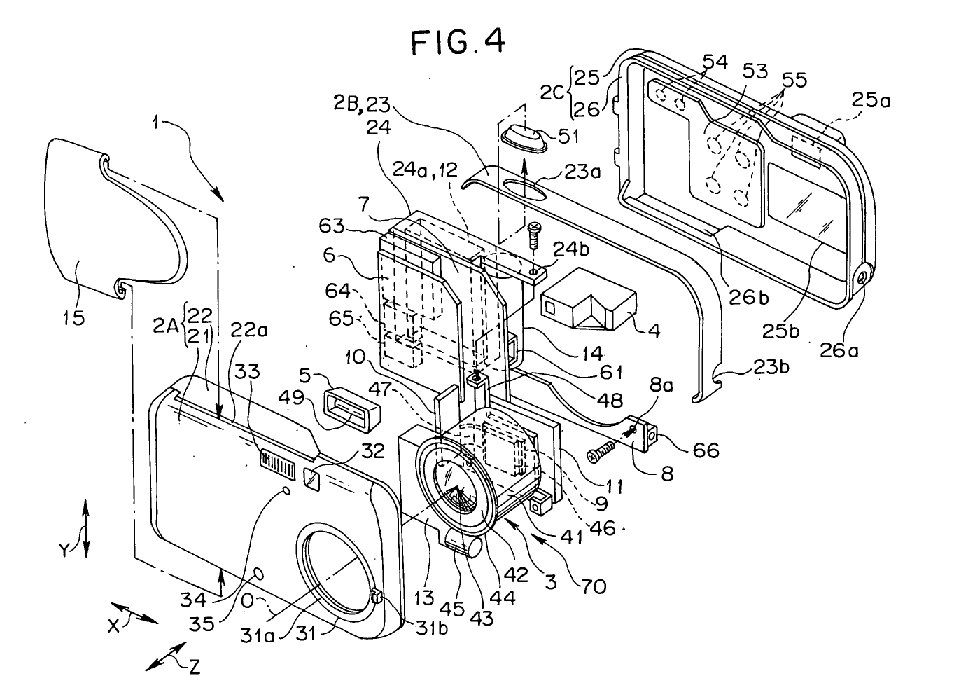

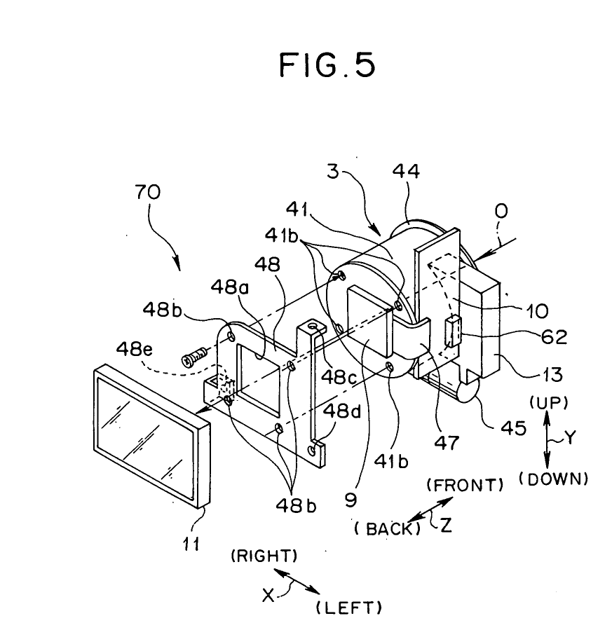

FIG. 1 is a perspective view showing the appearance of a digital camera according to an embodiment of the present invention. FIGS. 2 and 3 are perspective views showing the inner arrangement of the digital camera. FIG. 2 is a perspective view from the side of a subject. FIG. 3 is a perspective view from the top. FIG. 4 is an exploded perspective view showing the digital camera. FIG. 5 is an exploded perspective view showing an assembling unit around a lens barrel of the digital camera.

In the description of the arrangement of the digital camera according to the embodiment, the right/left direction (X direction in the drawing), serving as the camera width direction, is the right/left direction viewed from a subject side of the camera. With respect to the front/back direction (Z direction in the drawings, namely, direction along an optical axis O of a taking lens), the front direction is on the side of the subject and the back or rear direction is on the opposite of the subject. The up/down direction (Y direction in the drawing) is the up/down direction when the camera is held in the normal state.

A camera case 2 of a digital camera (hereinafter, referred to as a camera) 1 according to the embodiment comprises a front-cover unit 2A, a middle-cover unit 2B, a back-cover unit 2C, a connector cap 27, and a battery cap (not shown).

A collapsible-mount taking-lens barrel 3 is arranged at the opening in front of the front-cover unit 2A. A lens barrier 15 closes the front side of a taking lens 43 of the taking-lens barrel 3, and is attached slidably in the right/left direction to the front portion of the front-cover unit 2A. The lens barrier 15 is closed at the collapsible mount position of the taking lens 43. Hereinafter, the taking-lens barrel is abbreviated to a lens barrel.

A release switch operation button 51 is arranged to the top portion of the middle-cover unit 2B.

A finder eyepiece window portion 25a, an LCD display window portion 25b, and switch operation buttons 54 and 55 and the like are arranged to the back portion of the back-cover unit 2C. A closable battery cap (not shown) is arranged to the bottom portion of the back-cover unit 2C.

Further, the connector cap 27 is closably and rotatably supported to the left end of the back-cover unit 2C. The connector cap 27 opens/closes a video output terminal portion 64 or a USB terminal portion 65, serving as an external connector terminal portion, and a card opening of a card slot 63 for inserting a memory card (recording medium).

Next, the structure of the camera 1 according to the embodiment will be described with reference to FIG. 4.

The camera 1 comprises, as the camera case 2, the front-cover unit 2A, the middle-cover unit 2B, the back-cover unit 2C, the connector cap 27 (refer to FIG. 1), and the battery cap (not shown).

Further, the camera 1 comprises, serving as main components incorporated in the camera case 2, an assembling unit 70 around a lens barrel, a strobe light-emitting unit 5 including a strobe light-emitting tube 49, a finder unit 4 including a finder optical system, electric substrates (A)6, (B)7, and (C)8, a middle frame 24 having a battery chamber 24a for accommodating a power battery 12, a charging strobe condenser 14 for light emission of the strobe, the release switch operation button 51, and an operation switch substrate 53 and the like.

The assembling unit 70 around the lens barrel is a lens barrel unit including the lens barrel 3 and an LCD display unit 11.

The front-cover unit 2A is a case on the front side of the camera, and comprises a front-cover plate 21 which forms a metallic (Aluminum, or the like) thin-plate case and a resin assembling front-cover frame 22 which is adhered and is fixed to the inside of the front-cover plate 21.

The middle-cover unit 2B is a case in the center of the camera, and comprises a middle-cover plate 23 which forms a metallic (Aluminum, or the like) thin-plate case.

Similarly, the back-cover unit 2C is a case on the back side of the camera, and comprises a back-cover plate 25 which forms a metallic (Aluminum, or the like) thin-plate case, and a resin assembling back-cover plate 26 which is adhered and is fixed to the inside of the back-cover plate 25.

A screw (not shown) is inserted and is screwed into the front-cover frame 22 and the back-cover frame 26, thereby connecting the front-cover frame 22 and the back-cover frame 26. The case of the camera 1 mainly comprises the front-cover plate 21, the middle-cover plate 23, and the back-cover plate 25.

The front-cover plate 21 comprises, at the upper portion in the center, a strobe light-emitting window 33, a finder window 32, and a self-timer LED window 34. Further, the front-cover plate 21 comprises, at the down portion in the center, a window 35 for remote control. Furthermore, the front-cover plate 21 comprises, at the opening on the left, a front ring 31 having an opening 31a for taking lens, which is adhered and is fixed thereto. The front-cover frame 22 comprises a barrier guide groove 22a extended in the right/left direction at the up and down positions of the front-cover plate 21.

The lens barrier 15 is slidably fit into the barrier guide groove 22a. The lens barrier 15 is slid at the closing position (right position) for closing the opening 31a for taking lens and the strobe light-emitting window 33 and at the opening position (left position) for releasing them.

The front ring 31 comprises, at the right end on the outer circumference thereof, a barrier abutting projection 31b on which the end of the lens barrier 15 at the closing position can be abutted. When the lens barrier 15 at the closing position is pressed, the end of the lens barrier 15 is abutted on the projection 31b, thereby preventing the modification of the front-cover plate 21.

At the back position of the finder window 32 of the front-cover plate 21, the finder unit 4 including the finder optical system is arranged.

At the back position of the strobe light-emitting window 33 of the front-cover plate 21, the strobe light-emitting unit 5 including a strobe light-emitting tube 49 is arranged.

The middle-cover plate 23 comprises an opening 23a for release button and a notch portion 23b for DC terminal. The release switch operation button 51 is inserted into the opening 23a for release button.

On the left of the middle frame 24, a battery chamber 24a is arranged. The battery chamber 24a has a battery storage space in which the power battery 12 can be inserted from the downward opening. Further, on the top of the middle frame 24, a right projected portion is formed. Further, the middle frame 24 comprises, at the projected end thereof, a screw inserting hole 24b for fixing of a unit attaching plate 48, which will be described later. Furthermore, the middle frame 24 comprises, on the back thereof, a screw inserting hole for fixing (not shown) of the unit attaching plate 48. In addition, on the right of the middle frame 24 and in the down space of the right projected portion, a long space for accommodating the strobe condenser 14 along the up/down direction is formed.

The back-cover plate 25 comprises, on the back thereof, the finder eyepiece window portion 25a, an LCD window portion 52, the zoom switch buttons 54, and the mode setting buttons 55. Further, the back-cover plate 25 includes the operation switch substrate 53 which is operated by the zoom switch buttons 54 and the mode setting buttons 55.

The back-cover frame 26 comprises an opening 26a for DC-IN terminal at the down portion on the left thereof, and an opening 26b for inserting the battery having a closable battery cap (not shown) on the bottom thereof.

Mainly, a power circuit portion is mounted on the electric substrate (A)6.

The electric substrate (B)7 is a main control substrate, serving as a substrate on the front side of the battery chamber. An image processing circuit and various control circuit portions are mounted on the electric substrate (B)7. Further, mounted on the electric substrate (B)7 are the video output connector terminal 64, the USB connector terminal portion 65, a connector 61 for connection to an image pickup substrate 10, and the card slot 63 to which a memory card can be attached. The card slot 63 is inside of a card opening on the left end of the back-cover frame 26. The terminal portions 64 and 65 are inside of the opening of the terminal on the left end of the back-cover frame 26.

Mainly, a strobe control circuit portion and the strobe condenser 14 are mounted on the electric substrate (C)8. Further, a DC-IN terminal 66 as a DC connector terminal is mounted on the electric substrate (C)8. The DC-IN terminal 66 is inside of the opening 26a for DC-IN terminal on the right end of the back-cover frame 26.

The electric substrates (A)6 and (B)7 are apart by a predetermined distance on the front side of the middle frame 24, and are fixed and are supported thereto. The electric substrate (C)8 is fixed and is supported in the projecting state to the right of the middle frame 24. As will be described later, in the camera assembling state, the electric substrates (A)6 and (B)7 are arranged on the left side of the lens barrel 3 in front side of the battery chamber 24a, and the electric substrate (C)8 is arranged on the down side of the lens barrel 3.

Referring to FIGS. 4 and 5, the assembling unit 70 around the lens barrel comprises, as one unit, the lens barrel 3, the image pickup substrate 10, serving as an electric substrate on the side of the barrel, a lens driving unit 13, the LCD display unit 11, serving as an image display unit, and a unit attaching plate 48.

The lens barrel 3 comprises a fixing frame 41 to which a waterproof packing 44 is attached on the outer circumference thereof, a moving frame 42 which is supported to the fixing frame 41 movable in the optical axis O direction and holds a taking lens 43, and a CCD substrate 9, serving as an image pickup substrate, on which a CCD 46 is mounted at the position for forming the image of the taking lens 43 in the barrel.

The CCD substrate 9 is fixed and is supported in the state in which the principal plane thereof (the widest plane or principal plane on the function) is perpendicular to the optical axis O on the back surface (back surface of the lens barrel) of the fixing frame 41, and the CCD 46, serving as the image pickup element, is mounted at the position for forming the image of the taking lens 43 on the inside of the barrel. Further, an image pickup circuit is partly mounted on the outer surface of the barrel of the CCD substrate 9.

The lens driving unit 13 is arranged to be projected in the left direction on the front side of the fixing frame 41. Further, the lens driving unit 13 includes a driving-force transmitting portion, such as a gear, and a driving motor 45, serving as a lens driving source, at the down position. The lens driving unit 13 moves a moving frame 42 to perform the collapsible-mount operation and zoom operation.

The unit attaching plate 48 is a metallic attaching plate having a relief opening 48a for the CCD substrate 9, a screw inserting hole 48b arranged around the escape opening 48a, a screw hole 48c arranged at a upper-bent projected portion, a screw hole 48d arranged at down left projected portion, and a screw hole 48e arranged to a down right bent projected portion. Further, the unit attaching plate 48 is fixed onto the back of the fixing frame 41 by screwing a screw, via the screw inserting hole 48b, into a screw hole 41b arranged to the back surface perpendicular to the optical axis O of the fixing frame 41.

The LCD display unit 11 has an LCD which displays the picked-up image or various information data, and is adhered by a both-side adhesive tape and is fixed to the back surface of the unit attaching plate 48 while the LCD display surface is perpendicular to the optical axis O and is directed to the back. The LCD display unit 11 is partly projected in the side direction of the back of the fixing frame 41 of the lens barrel 3 in the fixing state.

Another part of the image pickup circuit and a connector 62 for connection to the electric substrate (B)7 are mounted on the image pickup substrate 10, and are connected to the CCD substrate 9 via a flexible printed board 47. The image pickup substrate 10 is positioned in the space sandwiched by the projected portion of the lens driving unit 13 and the left projected portion of the fixing frame 41 of the LCD display unit 11, and is fixed and supported to the fixing frame 41 with the principal plane thereof in parallel with the optical axis O and with the longitudinal direction thereof along the vertical (up/down) direction.

As mentioned above, in the assembling unit 70 around the lens barrel, the image pickup substrate 10, the unit attaching plate 48, and the LCD display unit 11 are assembled, as a unit, to the fixing frame 41 of the lens barrel 3 to which the lens driving unit 13 and the CCD substrate 9 are attached.

Upon assembling the components of the camera 1 to the camera case 2 of the camera 1, referring to FIG. 4, the strobe light-emitting unit 5 is adhered and fixed into the inner surface of the front-cover unit 2A. Further, the lens barrier 15 is inserted in the guide groove 22a and is slidably attached.

The assembling unit 70 around the lens barrel, as a unit, is attached, via the unit attaching plate 48, to the middle frame 24 to which the electric substrates (A)6, (B)7 and (C)8 are fixed and supported, and is assembled as a camera including block. That is, a screw is inserted in the screw inserting hole 24b of the middle frame 24 and another screw inserting hole (not shown). Further, screws are screwed to the screw hole 48c of the upper bend projected portion of the unit attaching plate 48 and the screw inserting hole 48d of the down left projected portion, thereby integrating the middle frame 24 and the assembling unit 70 around the lens barrel. The screw inserted in the screw inserting hole 8a arranged to the DC terminal side of the electric substrate (C)8 is screwed to the screw hole 48e of the unit attaching plate 48, and the end of the electric substrate (C)8 is fixed to the unit attaching plate 48. The connector 62 for connection of the image pickup substrate 10 is connected to the connection connector 61 of the electric substrate (B)7. Further, a finder unit is attached and is fixed and supported to the upper portion of the fixing frame 41 of the lens barrel 3.

Blocks incorporated in the camera including the electric substrates and the assembling unit 70 around the lens barrel are covered, sandwiching in the front-cover unit 2A and the back-cover unit 2C. A screw (not shown) is inserted to the back-cover frame 26 and is screwed into a screw hole (not shown) of the front-cover frame 22, thereby completing the camera 1.

In the camera assembling state, the front end of the fixing frame 41 of the lens barrel 3 is fit and is attached to the inner circumference of the front ring 31 attached to the front-cover unit 2A. The packing 44 arranged to the outer circumference of the fixing frame 41 is modified into a U-shaped cross section and is inserted to the inner circumference of the front ring 31, thereby setting the fitting space between the lens barrel 3 and the front-cover unit 2A to be watertight. The moving frame 42 of the inserted lens barrel 3 is fit to the opening 31a for taking lens of the front ring 31 via a watertight packing (not shown), thereby being advanced/returned at shooting positions projected in the front direction from the collapsible mount position at which the shooting is impossible. Further, when the moving frame 42 is at the collapsible mount position, the front surfaces of the moving frame 42 and the taking lens 43 are covered by the lens barrier 15. When the lens barrier 15 is slid at the releasing position for sheltering from the front surfaces of the moving frame 42 and the taking lens 43, the moving frame 42 is automatically moved to the shooting position. When the lens barrier 15 is at the closing position for covering the front surface of the taking lens 43 and then the lens barrier 15 is pressed by a user, the end of the lens barrier 15 comes into contact with the projected portion 31b of the front ring 31, thereby preventing the modification of the metallic thin-plate front-cover plate 21.

Here, a description is given of an arranging positional relationship of components in the camera 1 in the assembling state with reference to FIGS. 2 and 3.

In the camera 1 according to the embodiment, the lens barrel 3 is arranged on the right of the X direction (camera width direction) of the camera case 2. The image pickup substrate 10 connected to the CCD substrate 9 is arranged in the direction vertical to the X direction on the left side surface of the lens barrel 3, the left side surface constituting a side surface of the optical axis O. The LCD display unit 11 is arranged on the back portion of the lens barrel 3 with the display surface thereof in the direction perpendicular to the optical axis O. The battery chamber 24a for storing the battery 12 is arranged on the left of the X direction with the principal plane in the X direction on the left thereof. The strobe light-emitting unit 5 is arranged at the top position substantially in the center of the X direction. The strobe condenser 14 is arranged on the back position of the strobe light-emitting unit 5, namely, in the long space sandwiched by the battery chamber 24a and the image pickup substrate 10 while the longitudinal direction of the condenser matches the long direction of the space. Further, the electric substrate (B)7, serving as the electric substrate outside the battery chamber, is in front of the battery chamber 24a, and the principal plane of the electric substrate (B)7 is in the X direction to cover the back of the strobe condenser 14. Further, the end on the right of the electric substrate (B)7 is close to the image pickup substrate 10.

The LCD display unit 11 is supported to the fixing frame 41 of the lens barrel 3 to be projected on the left and right directions on the back of the fixing frame 41. The CCD substrate 9 on which the CCD 46 is mounted is arranged to the back of the lens barrel 3. The principal plane of the CCD substrate 9 is supported in the parallel direction of the LCD display unit 11. The image pickup substrate 10 is arranged in the space sandwiched by the left projected portion of the LCD display unit 11 and the lens driving unit 13 projected to the front left side of the fixing frame 41.

The light-emitting portion of the strobe light-emitting unit 5 and the objective window portion of the finder unit 4 are arranged in the strobe window portion 33 and the finder window portion 32 of the front-cover plate 21 on the back of thereof, respectively. The openings of the video output terminal portion 64 and the USB terminal portion 65 of the electric substrate (B)7 and the card slot 63 are simultaneously opened/closed by the connector cap 27. The DC-IN terminal 66 mounted on the electric substrate (C)8 is inside the opening 26a for DC-IN terminal of the front-cover frame 26. Further, the battery 12 is attached to the battery chamber 24a from the battery-chamber opening 26b on the bottom of the back-cover frame 26.

Upon picking-up an image by the camera 1 with the above-described structure according to the embodiment, the battery 12 is attached to the battery chamber 24a and the memory card is attached to the card slot 63. The lens barrier 15 is slid in the left direction and the front surface of the taking lens 43 is released. Then, the moving frame 42 is moved to the shooting position. The release switch operation button 51 is pressed at the moving position and then the CCD 46 generates an electrical signal of the subject image. The image data on the subjected through the image processing is recorded to the memory card.

In the digital camera 1 with the above-mentioned arrangement of the components according to the embodiment, the LCD display unit 11 is arranged on the back of the lens barrel 3 having the CCD substrate 9 arranged to the right of the camera, and the image pickup substrate 10 is arranged to the left of the lens barrel 3, thereby assembling the assembling unit 70 around the lens barrel as a unit. Thus, the foregoing contributes to the compact camera and the thin size thereof. Further, the camera assembling operation is easy. Furthermore, in the digital camera 1, the battery 24a and the electric substrates (A)6 and (B)7 are arranged to the left, the strobe light-emitting unit 5 is arranged to the top in the center of the camera, and the strobe condenser 14 is accommodated on the back of the strobe light-emitting unit 5, namely, in the long space sandwiched by the battery chamber 24a and the lens barrel 3. Thus, the camera is compact and thin without deterioration in original functions of the camera. As mentioned above, the digital camera is provided with high mobility and high convenience.

The present invention is not limited to the embodiment and can be modified and be applied without departing from the essentials of the present invention.

### INDUSTRIAL APPLICABILITY

As mentioned above, according to the present invention, the components are structured as a unit, thereby realizing the easy assembling. Further, the inner components are effectively arranged and the camera is thus compact without deterioration in original functions of the camera.

1. A digital camera comprising:
a taking-lens barrel arranged on the right of the camera as viewed from a subject;
an electric substrate on the side of the barrel attached to the side surface on the left as viewed from the subject of the taking-lens barrel in the vertical direction of a camera width direction;
an image display unit attached to the back of the taking-lens barrel;
a battery chamber having therein a battery storage space, arranged on the left of the camera as viewed from the subject with a principal plane thereof in the camera width direction;
a strobe light-emitting unit arranged upward of the front and nearly the center of the camera width direction; and
a strobe condenser arranged on the back of the strobe light-emitting unit in a long space formed sandwiched by the electric substrate and the battery chamber in the direction in which the longitudinal direction of the strobe condenser matches the long direction of the space.

2. A digital camera according to claim 1, further comprising:
an electric substrate in front of the battery chamber close to a substrate surface of the electric substrate on the side of the barrel at one end thereof, attached to the front side of the battery chamber in the camera width direction and arranged to cover the front side of the strobe condenser.

3. A digital camera comprising:
a taking-lens barrel including a taking lens and an image pickup element;
a lens driving unit for moving the taking lens, attached to one side in front of the taking-lens barrel to be at least partly projected from the side of the taking-lens barrel;
an image display unit arranged to the back of the taking-lens barrel in the parallel direction of the back of the taking-lens barrel to be partly projected from the back of the taking-lens barrel in the same side direction as the projected direction of the lens driving unit; and
an image pickup substrate arranged on the side of the taking-lens barrel, sandwiched by the lens driving unit and the projected portion of the image display unit along the side of the lens barrel.

4. A digital camera according to claim 3, further comprising:
an image pickup element substrate, on which the image pickup element is mounted, between the image display unit and the back of the lens barrel in parallel with the image display unit.

5. A lens barrel unit for digital camera, comprising:
an electric substrate on which an image pickup element is mounted;
a taking-lens barrel including a taking lens for forming a subject image onto the image pickup element; and
an image display unit for displaying the image based on an image signal obtained by the image pickup element,
wherein the electric substrate is attached to the back of the taking-lens barrel and the image display unit is attached for integration, in parallel with the electric substrate to cover the electric substrate.

6-10. (canceled)
